(19) United States
(12) Patent Application Publication
(10) Pub. No.: US 2023/0108791 A1
(43) Pub. Date: Apr. 6, 2023

(54) DELAY MEASUREMENT DEVICE, DELAY MEASUREMENT METHOD, AND PROGRAM

(71) Applicant: Nippon Telegraph and Telephone Corporation, Tokyo (JP)

(72) Inventors: Hiroki Mori, Musashino-shi, Tokyo (JP); Takayoshi Hirasawa, Musashino-shi, Tokyo (JP); Satoshi NAKATSUKASA, Musashino-shi, Tokyo (JP); Ken TAKAHASHI, Musashino-shi, Tokyo (JP)

(21) Appl. No.: 17/799,737

(22) PCT Filed: Feb. 21, 2020
(86) PCT No.: PCT/JP2020/007257

§ 371 Date: Aug. 15, 2022

(51) Int. Cl. H04L 45/02

(52) U.S. Cl. CPC H04L 45/02

(57) ABSTRACT

A latency measurement apparatus (10) includes a topology detection unit (13) that collects routing information from a NW (30) to which a plurality of nodes are connected to detect topology information, a path determination unit (14) that determines inter-node path information based on the topology information, a test packet generation unit (15) that generates a test packet, a marking unit (20) that performs time-keeping with a time-keeping unit (19), marks the test packet with transmission time information based on the time-keeping when the test packet is transmitted to the path according to the inter-node path information, and marks the test packet with reception time information based on the time-keeping when the test packet is received from the path, and a latency calculation unit (17) that calculates a latency time from a difference between the marked transmission time information and reception time information and stores the calculated latency time information in a DB (16) in association with the path information.

### TECHNICAL FIELD

The present invention relates to a latency measurement apparatus, a latency measurement method, and a program for measuring a latency time on a communication network with high accuracy.

### BACKGROUND ART

A communication network (NW) that requires low latency as represented by 5th generation (5G) networks needs to be appropriately controlled and operated according to the amount of latency of the NW. For this reason, it is necessary to measure and ascertain latency states of the NW with high accuracy. An amount of latency of a NW is measured using a “ping” which is software when deploying measurement apparatuses at both ends of a segment to be measured to check accessibility of nodes as communication apparatuses on the IP network.

Such an amount of latency is measured using, for example, a round-trip time (RTT) of a packet of an Internet control message protocol (ICMP), like a ping, or a Two-Way Active Measurement Protocol (TWAMP) (NPL 1) that is a protocol for ascertaining NW states.

Because a CPU performs such measurement process, the measurement results vary due to the performance of each measurement apparatus, and conflicts with other processing, and accurate measurement for times like milliseconds or shorter is difficult. In addition, because the measurement is performed based on different time information held by individual measurement apparatuses, the measurement may be affected by an error of the time information. Thus, as described in NPL 2, a technique of reducing such variance in measurement results by separating ICMP packets on the forward path and the return path has been proposed.

### CITATION LIST

### Non Patent Literature

NPL 1: RFC3557, A Two-Way Active Measurement Protocol (TWAMP), [online], [retrieved on Feb. 7, 2020], Internet <https://tools.ietf.org/html/rfc5357>
NPL 2: C. Pelsser et al., “From Paris to Tokyo: On the Suitability of Ping to Measure Latency”, Proceedings of the 2013 Conference on Internet Measurement Conference. ACM, 2013.

### SUMMARY OF THE INVENTION

### Technical Problem

However, because a transmission path for ICMP packets is defined based on the routing protocol in the technique of PTL 2, it is not possible to measure latency in a required node segment. For this reason, it is difficult to ascertain the latency state of each node segment through a NW. Furthermore, because a large-scale NW needs an increased number of measurement apparatuses, it has a problem that the costs incurred for the measurement are high.

The present invention has been made in view of such circumstances, and aims to measure latency in a required node segment on a communication network and to ascertain latency at each node segment through the network at low cost.

### Means for Solving the Problem

To solve the above-described problem, a latency measurement apparatus according to the present invention includes: a detection unit that collects routing information from a communication network formed by a plurality of nodes network-connected to one another to detect topology information, the routing information indicating an inter-node connection state; a path determination unit that determines inter-node path information of nodes to be measured for latency based on the detected topology information; a generation unit that generates a packet to be transmitted on a path based on the determined path information; a marking unit that performs time-keeping and performs transmission and/or reception of a packet, marks the packet generated by the generation unit with transmission time information based on the time-keeping when the packet is transmitted to the path according to the inter-node path information, and marks the packet with reception time information based on the time-keeping when the packet is received from the path; and a calculation unit that calculates a latency time from a difference between the transmission time information and the reception time information marked on the packet and stores the calculated latency time information in a database (DB) in association with the inter-node path information related to the latency time information.

### Effects of the Invention

According to the present invention, latency in a required node segment on a communication network can be measured and latency at each node segment throughout the entire network can be ascertained at low cost.

### BRIEF DESCRIPTION OF DRAWINGS

FIG. 1 is a block diagram illustrating a configuration of a latency measurement apparatus according to an embodiment of the present invention.

FIG. 2 is a block diagram illustrating inter-node packet transmission directions on a NW to which a topology detection unit is connected.

FIG. 3 is a block diagram illustrating a loop path and a round-trip path of a packet on the node path of the NW.

FIG. 4 is a block diagram illustrating the full round-trip path of a packet on the node path of the NW.

FIG. 5 is a diagram illustrating payloads, header, and label sequences of test packets PR1 to PR3.

FIG. 6 is a diagram illustrating the label sequence with the end label of the test packet PR1 removed.

FIG. 7 is a diagram illustrating the label sequence with the second label removed from the end of the test packet PR1.

FIG. 8 is a diagram illustrating the payload and the header with all of the labels of the test packet PR1 removed.

FIG. 9 is a hardware configuration diagram illustrating an exemplary computer that realizes functions of a test packet generation apparatus.

FIG. 10 is a flowchart for describing a latency measurement operation of the latency measurement apparatus according to the present embodiment.

FIG. 11 is a block diagram illustrating exemplary transmission and reception of a test packet from the latency measurement apparatus and the NW.

FIG. 12 is a table diagram of latency time information stored in a DB.

FIG. 13 is a table diagram showing an exemplary determination aspect of a result determination unit.

### DESCRIPTION OF EMBODIMENTS

Hereinafter, embodiments of the present invention will be described with reference to the drawings. However, the same reference signs are given to constituent components having corresponding functions in all drawings of the present specification, and description thereof will be omitted as appropriate.

### Configuration of Embodiment

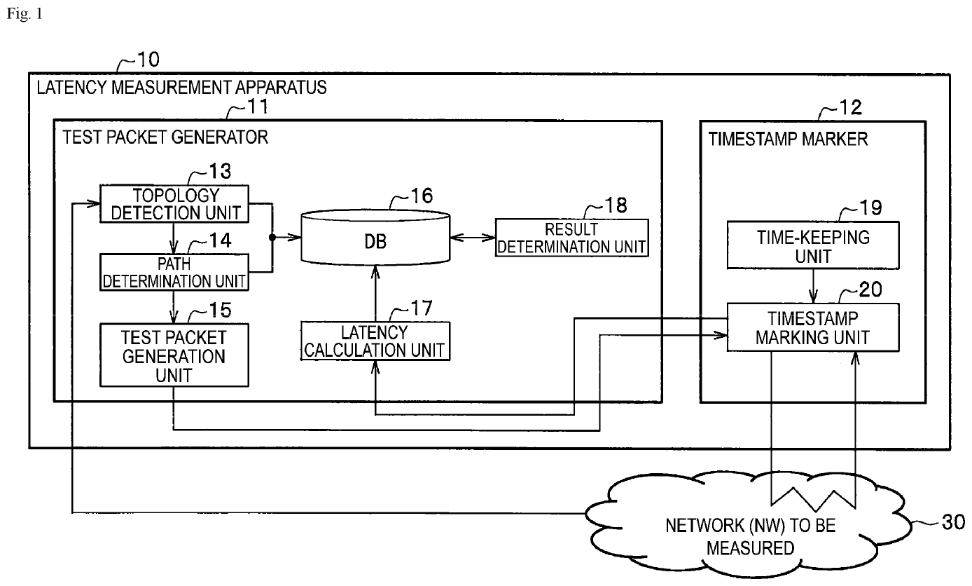

FIG. 1 is a block diagram illustrating a configuration of a latency measurement apparatus according to an embodiment of the present invention.

The latency measurement apparatus 10 illustrated in FIG. 1 is connected to a network (NW or communication network) 30 to be measured for latency and includes a test packet generator 11 and a timestamp marker 12. However, although the test packet generator 11 and the timestamp marker 12 are incorporated into the latency measurement apparatus 10, each may be realized as a separate device.

The test packet generator 11 includes a topology detection unit 13, a path determination unit 14, a test packet generation unit 15, a data base (DB) 16, a latency calculation unit 17, and a result determination unit 18. Further, the topology detection unit 13 configures the detection unit described in the claims, the test packet generation unit 15 configures the generation unit, the latency calculation unit 17 configures the calculation unit, and the result determination unit 18 configures the determination unit.

The timestamp marker 12 includes a time-keeping unit 19 and a timestamp marking unit 20, each of which is formed as hardware. Both the time-keeping unit 19 and the timestamp marking unit 20 form the marking unit described in the claims.

The topology detection unit 13 collects information of the routing protocol operated at a NW 30 to detect topology information that is a connection form of the NW 30. Examples of the information of the routing protocol include an open shortest path first (OSPF)-link state (LS), a border gateway protocol (BGP)-link state (LS), and the like.

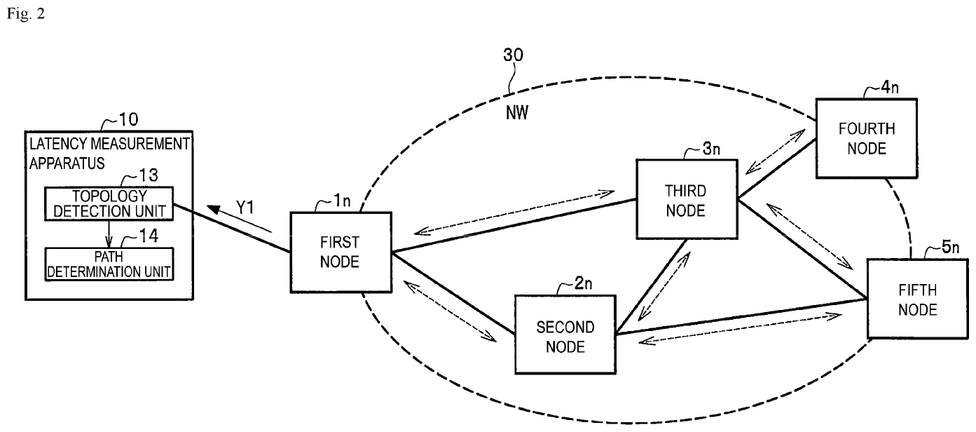

Here, it is assumed that the NW 30 includes a first node 1n, a second node 2n, a third node 3n, a fourth node 4n, and a fifth node 5n as communication apparatuses as illustrated in FIG. 2. The NW 30 is assumed to be formed with these constituent components such that the first node 1n, the second node 2n, and the third node 3n are connected, the second node 2n, the third node 3n, and the fifth node 5n are connected, and the third node 3n, the fourth node 4n, and the fifth node 5n are connected. In addition, a test packet can be transmitted on each path in both directions as indicated by the double-headed arrows on the connection paths between the nodes 1n to 5n. The test packet constitutes the packet described in the claims.

It is assumed that the latency measurement apparatus 10 is connected to the first node 1n of the NW 30 with this configuration. That is, the latency measurement apparatus 10 serves as the start/end point of test packet transmission. The first node 1n serves as the start/end point on the NW 30. Here, a test packet transmitted from the latency measurement apparatus 10 to the first node 1n is designed to pass through the second to the fifth nodes 1n to 5n in an arbitrary route, and return to be received by the latency measurement apparatus 10 via the first node 1n as indicated by the arrow Y1.

The topology detection unit 13 collects routing protocol information (routing information) such as OSPF-LS/BGP-LS, as indicated by the arrow Y1, and generates topology information of the NW 30 based on this routing information. In other words, the topology detection unit 13 detects topology information. Further, the topology information can be input manually. The topology information is information representing a network connection form (or a node connection form) in which the first to fifth nodes 1n to 5n are connected as illustrated in FIG. 2.

The path determination unit 14 calculates information of the path of the NW 30 on which the test packet is transmitted (or forwarded) for latency measurement based on the detected topology information. That is, the calculation determines the path information. Methods of calculation of the path information include a calculation method 1 for path information of a loop path of the NW 30 and a calculation method 2 for path information of a round-trip path.

Calculation Method 1

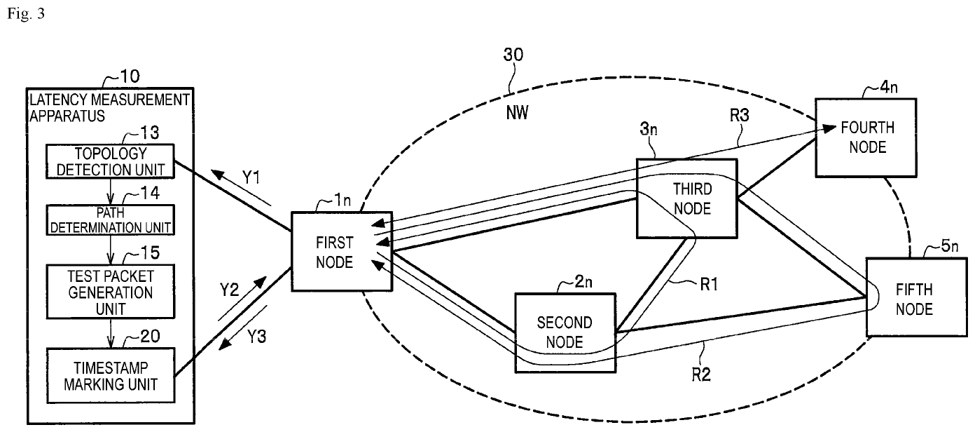

It is assumed in the calculation method 1 that all pieces of path information for passing through a loop in which the first node 1n of the NW 30 is used as a start/end point without passing through the same link, in other words, path information for passing through different loops, are calculated. In the calculation method 1, path information R1 and R2 of the first to fifth nodes 1n to 5n illustrated in FIG. 3 is calculated, for example. In addition, in the calculation method 1, path information R3 representing a round trip between the node serving as the start/end point and a desired node is calculated.

It is assumed in the calculation method 1 that whether a path is rightward or leftward from the nodes is considered and a link that has been passed through once cannot be passed through even in the reverse direction. For example, if the link between the nodes 1n and 3n has been passed through in the direction from the node 1n to the node 3n, the link cannot be passed through in the reverse direction from the node 3n to the node 1n. In other words, it is assumed that connection information cannot be generated. As another example, it is assumed that it is neither possible to pass through the path from the node 1n to reach 4n via the node 3n and from the node 4n to reach the node 1n via the node 3n nor can the path information be generated.

However, it is assumed that, in a case in which it is not possible to return to the start point unless the same link is passed through, for example, in a case of a node having only one link, such as the fourth node 4n, it is allowed to pass through the same link. This rule is applied to the path information R3 described below.

Using the calculation method 1, the path determination unit 14 calculates path information R1 to R3 required for latency measurement based on the topology information representing the node connection form illustrated in FIG. 3. The path information R1 to R3 is represented by the following examples using reference signs 1n to 5n of the first to fifth nodes 1n to 5n.

The path information R1 includes, for example, “1n-2n-3n-1n”, representing the path on which the nodes are passed through in order from the left (head) node to the right (end) node in the sequence of the reference signs. That is, the path information R1 represents a loop path on which the nodes 1n, 2n, 3n, and 1n are passed through counterclockwise (turning leftward).

The path information R2 includes, for example, “1n-3n-5n-2n-1n” representing a loop path for traveling through the nodes 1n, 3n, 5n, 2n, and 1n in the rightward direction.

The path information R3 includes, for example, “1n-3n-4n-3n-1n”, representing a round-trip path for a round-trip through the nodes 1n, 3n, 4n, 3n, and 1n.

The path information R1 to R3 can be calculated manually by a user based on topology information, and the calculation result can be input as path information to the test packet generation unit 15 described below.

Calculation Method 2

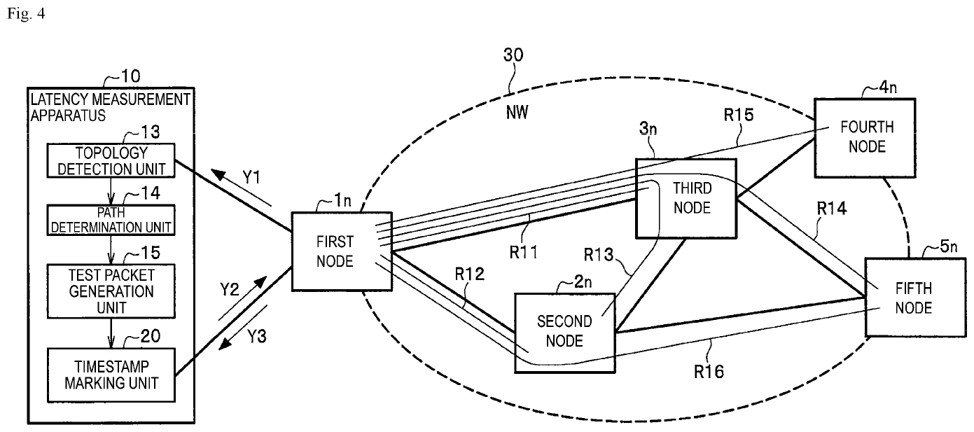

The calculation method 2 is for the path determination unit 14 to calculate all of path information of round-trip paths using the first node 1n of the NW 30 as a start/end point. For example, a case in which the path determination unit 14 calculates path information R11, R12, R13, R14, R15, and R16 of round-trip paths of the first to fifth nodes 1n to 5n illustrated in FIG. 4 will be described.

The path information R11 includes, for example, “1n-3n-1n” representing a round-trip path for a round-trip between the head “1n” and the end “3n” of the sequence of the reference signs. In other words, the path information R11 represents a round-trip path for a round-trip between the first node 1n and the third node 3n.

The path information R12 includes, for example, “1n-2n-1n”, representing a round-trip path between the first node 1n and the second node 2n.

The path information R13 includes, for example, “1n-3n-2n-3b-1n”, representing a round-trip path from the first node 1n to the second node 2n via the third node 3n.

The path information R14 includes, for example, “1n-3n-5n-3b-1n”, representing a round-trip path from the first node 1n to the fifth node 5n via the third node 3n.

The path information R15 includes, for example, “1n-3n-4n-3b-1n”, representing a round-trip path from the first node 1n to the fourth node 4n via the third node 3n.

The path information R16 includes, for example, “1n-2n-5n-2b-1n”, representing a round-trip path from the first node 1n to the fifth node 5n via the second node 2n.

In the calculation method 2, path information of a round-trip path on which a test packet can be transmitted from the node serving as the start/end point to a node other than the start/end point on the NW 30 is calculated. If the calculated path information of two different round-trip paths is compared, the necessary link of the node segment can be extracted.

For example, when it is desired to obtain a latency time between the third node 3n and the fourth node 4n on the NW 30, no test packet can be transmitted only between the third node 3n and the fourth node 4n. Thus, when the difference between the path information R11 “1n-3n-1n” and the path information R15 “1n-3n-4n-3n-4n” is calculated, “3n-4n” is acquired. That is, connection information “3n-4n” for the segment between the nodes 3n and 4n can be acquired. Thus, the round-trip latency time between the nodes 3n and 4n can be acquired from the difference between the latency time of the path information R11 and the latency time of the path information R15. Likewise, it is possible to acquire the round-trip latency time (or one-way latency time) of the node segment that is the only segment unavailable for transmission of the test packet.

Further, by measuring a latency on the NW 30 during a non-congested time such as the middle of the night, it is possible to measure the absolute amount of latency depending on the transmission distance in which the influence of convergence can be ignored and to detect the presence or the value of change in latency by periodically measuring the absolute amount of latency.

In addition, the path determination unit 14 extracts a combination in which all links in the transmission directions on the NW 30 are necessarily included from the calculated path information. Due to this extraction, at least one test packet is set to pass through all links in each direction on the NW 30. For example, although the test packet is transmitted counterclockwise in the link of the path information R1 illustrated in FIG. 3, the test packet can be conversely transmitted in the rightward direction. This bi-directional transmission is likewise applied to the link of the path information R3.

Furthermore, if all of the nodes 1n to 5n are necessarily connected such that two or more nodes are connected (if the fourth node 4n and the fifth node 5n are connected in FIG. 3), it is possible to identify the link and the direction (rightward or leftward) in which a latency has occurred, and the amount of change of the latency with the combination of the calculation methods 1 and 2 as follows.

(1A) For a round-trip from the node 1n to the node 5n via the node 3n as illustrated in FIG. 4, for example, the difference “8” of latency “10” of the previous time and latency “18” of this time is calculated.

(2A) Meanwhile, it is assumed that latency has increased from “10” of the previous time to “18” of this time, for example, in the rightward direction in which the loop from the node 1n to the node 5n via the node 3n of FIG. 3 is passed through. On the other hand, it is assumed in the leftward direction in this loop that the latency does not change from “8” of the previous time to “8” of this time. In this case, it is possible to calculate an increase in the rightward direction and no-change in the leftward direction from the difference in latency between the previous time and this time in the rightward direction or the leftward direction.

Thus, it is possible to ascertain from the results of (1A) and (2A) described above that latency has increased by “8” in the transmission loop in the direction from the first node 1n to the node 5n via the node 3n (rightward loop).

Returning to FIG. 1, the test packet generation unit (also referred to as a generation unit) 15 generates a test packet that will pass through the path information R1 to R3 determined above. At this time, the test packet can be transferred in any path segment by realizing the transfer of the test packet on the NW 30 with a label switching manner, which will be described below, or transfer for which the flow can be controlled.

Examples of the label switching manner include multi-protocol label switching (MPLS) and segment routing that are packet transfer techniques using tags that are called labels. In segment routing, a communication path can be specified or prioritized based on information added to the payload and header of a test packet at the entrance of the NW 30. The test packet generated by the generation unit 15 as described above is output to the timestamp marking unit 20.

An example of flow control includes open flow, or the like, as a technology in which communication devices forming a communication network are intensively managed by a single control apparatus to control complex transfers and flexibly change a network configuration.

However, the destination of the test packet is assumed to be the latency measurement apparatus 10 at all times. By determining the path so that the destination of the test packet is the latency measurement apparatus 10, the test packet transmitted from the latency measurement apparatus 10 can be received by the same apparatus (latency measurement apparatus 10). This enables latency to be measured solely by the single latency measurement apparatus 10.

In addition, it is possible to measure latency times with different priorities on the same path with the generation unit 15 setting priorities of packets (COS/DSCP, etc.) together for paths other than the transfer path. Further, class of service (CoS), differentiated services code point (DSCP), or experimental (Exp), or the like that are values representing a priority of communication may be used for the priority of a test packet.

In addition to the connection information of a path described above, for example, priority 1 and priority 7 may be set as a priority in the header of a test packet. This setting enables latency to be measured for each communication service on the same path. When a test packet with priority 7 such as a packet for a phone service and a test packet with priority 1 such as a packet for an Internet service enter the same node, the test packet with priority 7 will be preferentially transmitted.

The time-keeping unit 19 performs time-keeping by receiving time information from a network time protocol (NTP) server, the Global Positioning System (GPS), or the like that sends accurate time information or performs time-keeping with a function of keeping accurate time provided inside, and outputs the time-keeping information to the marking unit 20.

The timestamp marking unit (also referred to as a “marking unit”) 20 inserts (also called “marking”) the time information into the generated test packet and transmits the information to the NW 30. In other words, the test packet is marked with the time information at the time when the packet is transmitted to the NW 30 (transmission time information Tin or a timestamp Tin).

In addition, the marking unit 20 marks the time information on a test packet received back from the NW 30. In other words, a test packet is marked with the time information at the time when the packet is received from the NW 30 (reception time information Tout or a timestamp Tout). The test packet with the marking is output to the latency calculation unit 17. Further, the transmission time information Tin is also referred to as a transmission time Tin, and the reception time information Tout is also referred to as a reception time Tout.

The latency calculation unit 17 calculates a latency time from the difference between the transmission time Tin and the reception time Tout marked on the test packet, associates the information of the latency time with the path information of the path that the test packet has passed through, and stores the associated information in the DB 16. This stored latency time information and passed path information are also referred to as stored information.

The result determination unit 18 determines the state of the NW 30 based on stored information in the DB 16. This determination determines whether the difference between the previous measurement cycle and the current measurement cycle exceeds a certain percentage when the test packet is transmitted and/or received on the NW 30 at a constant period. In addition, it is determined, based on the result of training on the stored information of the test packet transmitted and/or received at a predetermined cycle for a certain period, whether the latency has a significant gap with respect to the average value, how long the gap has continued, or whether the latency time is tending to increase or decrease. These determination results serve as grounds to estimate a change in topology caused by failure, an increase in queuing latency due to congestion, a segment in which the amount of latency has varied, a transmission direction, and the like as states of the NW 30.

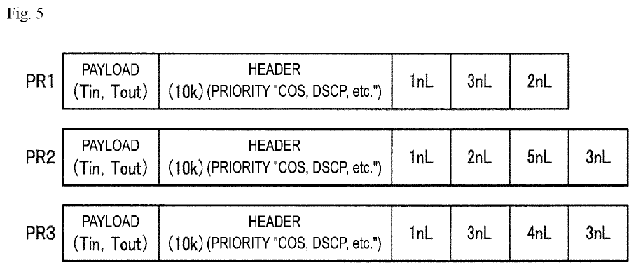

Next, FIG. 5 illustrates exemplary test packets PR1 to PR3 generated by the test packet generation unit 15. The test packets PR1 to PR3 are generated based on the path information R1 to R3 determined by the path determination unit 14.

The test packet PR1 has an insertion of a payload, a header, and 1 nL, 3 nL, and 2 nL as labels as described above. The transmission time information Tin is marked on the payload at the time of transmission, and the reception time information Tout is marked on the payload at the time of reception. The header has an insertion of destination information 10k indicating information unique to the latency measurement apparatus 10 serving as the start/end point and priority (COS, DSCP, and the like).

Similarly, the test packet PR2 has an insertion of a payload, a header, and labels 1nL, 2 nL, 5 nL, and 3 nL. The test packet PR3 has an insertion of a payload, a header, and labels 1nL, 3 nL, 4 nL, 3 nL, and 1nL.

Reading of the labels of the test packets PR1 to R3 will be described by exemplifying the test packet PR1 transmitted in the leftward direction and the test packet PR3 transmitted in a round-trip manner.

First, the labels 1nL, 3 nL, and 2 nL of the test packet PR1 are read from the end to the head by a node in order of 2 nL, 3 nL, and 1nL. However, because the first node 1n is the start/end point on the NW 30, the label 1nL indicating the end point is inserted next to the header, but the label 1nL indicating the start point is not inserted in the test packet PR1.

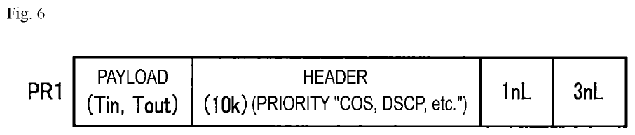

It is assumed that the test packet PR1 has been transmitted from the generation unit 15 to the first node 1n, as indicated by the arrow Y2 in FIG. 3. In this case, the first node 1n reads the label 2 nL at the end illustrated in FIG. 5, removes the label 2 nL from the test packet PR1 as illustrated in FIG. 6, and then transfers the label 2 nL to the second node 2n. That is, the test packet PR1 to be transferred has 3 nL at the end.

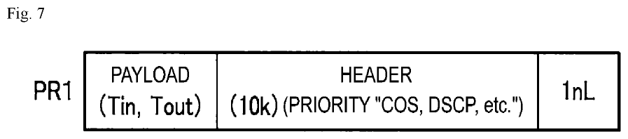

Next, when the second node 2n receives the test packet PR1, the node reads the label 3 nL at the end, removes the label 3 nL from the test packet PR1 as illustrated in FIG. 7, and then transfers the packet to the third node 3n. At this point, 1nL is positioned at the end.

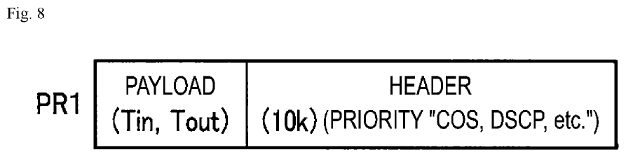

Next, when the third node 3n receives the test packet PR1, the node reads the label 1nL at the end, removes the label 1nL from the test packet PR1 as illustrated in FIG. 8, and then transfers the packet to the first node 1n. At this point, the test packet PR has no labels. When the first node 1n receives the test packet PR1, the node reads the destination information 10k at the header, and transmits the packet to the timestamp marking unit 20 as indicated by the arrow Y3 in FIG. 3.

Next, the test packet PR3 illustrated in FIG. 5 is read in order from the end to the head of the labels 1nL, 3 nL, 4 nL, and 3 nL. That is, when the test packet PR3 with “the labels 1nL, 3 nL, 4 nL, and 3 nL” is transmitted from the generation unit 15 to the first node 1n as indicated by the arrow Y2 in FIG. 3, the first node 1n reads the label 3 nL at the end, removes the label 3 nL from the test packet PR1, and then transfers the test packet to the third node 3n. The transferred test packet PR1 has 4 nL at the end.

Next, when the third node 3n receives the test packet PR1, the nodes reads and removes the label 4 nL at the end, and then transfers the test packet to the fourth node 4n. At this point, 3 nL is positioned at the end.

Next, when the fourth node 4n receives the test packet PR1, the node reads and removes the end label 3 nL at the end, and then transfers the test packet to the third node 3n. At this point, 1nL is positioned at the end.

Next, when the node 3nL receives the test packet PR1, the node reads and removes the label 1nL at the end, and then transfers the packet to the first node 1n. At this point, the test packet PR has no labels. When the first node 1n receives the test packet PR1, the node reads the destination information 10k at the header, and transmits the test packet to the marking unit 20 as indicated by the arrow Y3 in FIG. 3.

Hardware Configuration

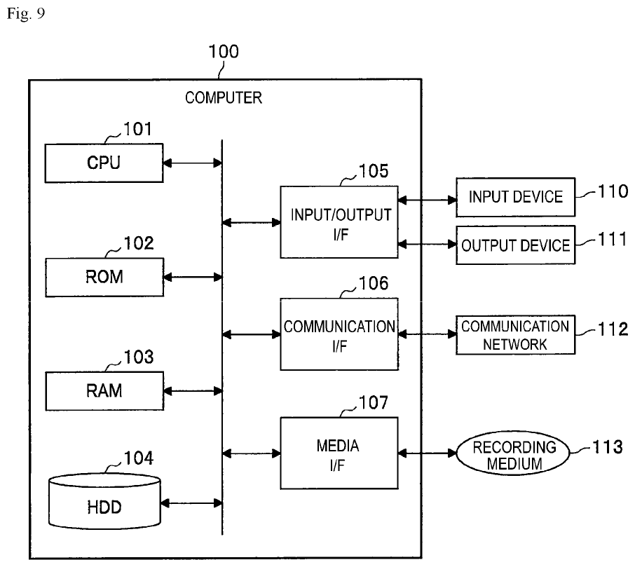

The test packet generator 11 described above is realized by, for example, a computer 100 configured as illustrated in FIG. 9. Hereinafter, the test packet generator 11 will be described as an example. FIG. 9 is a hardware configuration diagram illustrating an exemplary computer 100 that realizes functions of a test packet generator 11. The computer 100 includes a central processing unit (CPU) 101, a read only memory (ROM) 102, a random access memory (RAM) 103, a hard disk drive (HDD) 104, an input/output interface (I/F) 105, a communication interface (I/F) 106, and a media I/F 107.

The CPU 101 operates according to a program stored in the ROM 102 or the HDD 104, and controls each of the functional units. The ROM 102 stores a boot program that is executed by the CPU 101 when the computer 100 is activated, a program for the hardware of the computer 100, and the like.

The CPU 101 controls an output device 111 such as a printer or a display, and an input device 110 such as a mouse or keyboard via the input/output I/F 105. The CPU 101 acquires data from the input device 110 or outputs generated data to the output device 111 via the input/output I/F 105.

The HDD 104 stores a program executed by the CPU 101, data used by the program, and the like. The communication I/F 106 receives data from another apparatus (not illustrated) through a communication network 112 and outputs the received data to the CPU 101, and transmits data generated by the CPU 101 to another apparatus through the communication network 112.

The media I/F 107 reads a program or data stored in a recording medium 113 and outputs the program or data to the CPU 101 via the RAM 103. The CPU 101 loads a program for an intended process from the recording medium 113 in the RAM 103 via the media I/F 107 and executes the loaded program. The recording medium 113 is an optical recording medium such as a digital versatile disc (DVD) and a phase change rewritable disk (PD), a magneto-optical recording medium such as a magneto optical disk (MO), a magnetic recording medium, a conductor memory tape medium, a semiconductor memory, or the like.

For example, when the computer 100 functions as the test packet generator 11 according to the embodiment, the CPU 101 of the computer 100 executes a program loaded on the RAM 103 to implement the function of the test packet generator 11. In addition, the HDD 104 stores data inside the RAM 103. The CPU 101 reads a program for an intended process from the recording medium 113 to execute the program. Furthermore, the CPU 101 may read a program for an intended process from another apparatus via the communication network 112).

### Operation of Embodiment

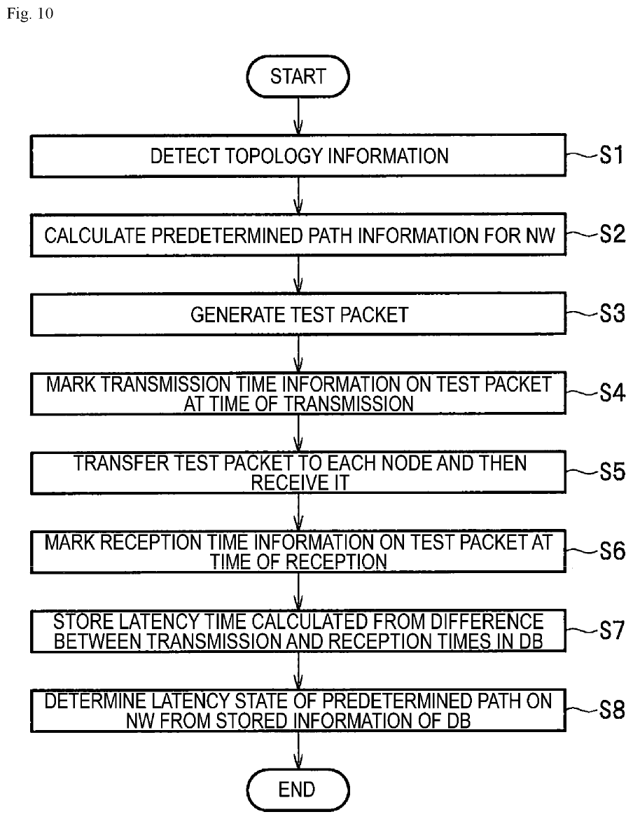

Next, a latency measurement operation using the latency measurement apparatus 10 according to the present embodiment will be described with reference to the flowchart of FIG. 10.

In step S1 shown in FIG. 10, the topology detection unit 13 collects routing information such as OSPF-LS/BGP-LS from the NW 30, as indicated by the arrow Y1 in FIG. 2, detects topology information of the NW 30, and outputs the information to the path determination unit 14.

Next, in step S2, the path determination unit 14 calculates path information of the NW 30 based on the topology information. For example, it is assumed that the path information R1 illustrated in FIG. 5 described above has been calculated.

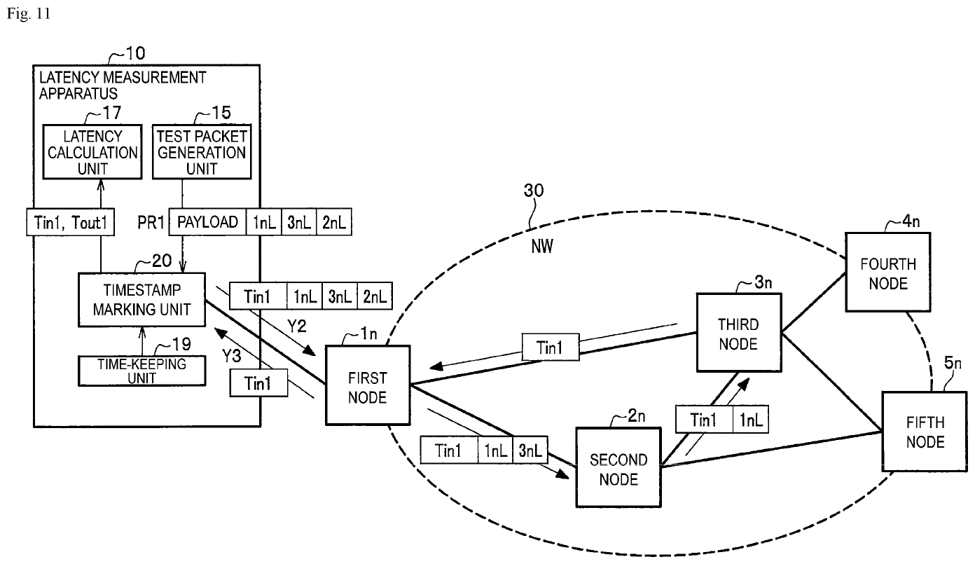

Next, in step S3, the test packet generation unit 15 illustrated in FIG. 11 generates the test packet PR1 based on the path information R1 determined in step S2, and outputs the test packet PR1 to the timestamp marking unit (also referred to as a “marking unit”) 20. During the generation, the destination information 10k of the latency measurement apparatus 10 is described in the header of the test packet PR1.

In step S4, when the input test packet PR1 is to be transmitted, the marking unit 20 marks the payload of the test packet PR1 with time-keeping information kept by the time-keeping unit 19 as transmission time information Tin1. The test packet PR1 after the marking is transmitted to the first node 1n, as indicated by the arrow Y2.

In step S5, after the test packet PR1 received by the first node 1n is transferred to each of the nodes 2n, 3n, and 1n corresponding to the labels 1nL, 3 nL, and 2 nL described in the test packet PR as described below, the test packet is returned back to and received by the marking unit 20, as indicated by the arrow Y3.

In other words, the first node 1n reads the label 2 nL at the end, removes the label 2 nL from the test packet PR1, and then transfers the test packet to the second node 2n. The transferred test packet PR1 has 3 nL at the end.

Next, the second node 2n reads the label 3 nL at the end of the test packet PR1, removes the label 3 nL, and then transfers the test packet to the third node 3n. Next, the node 3n reads the label 1nL at the end of the test packet PR1, removes the label 1nL, and then transfers the test packet to the first node 1n. The first node 1n reads the destination information 10k in the header of the test packet PR1, and transmits the test packet to the marking unit 20 as indicated by the arrow Y3.

Next, in step S6, upon receiving the test packet PR1, the marking unit 20 marks the test packet with the time-keeping information kept by the time-keeping unit 19 as reception time information Tout1 in the payload. The test packet PR1 marked with Tin1 and Tout1 in the payload is output to the latency calculation unit 17.

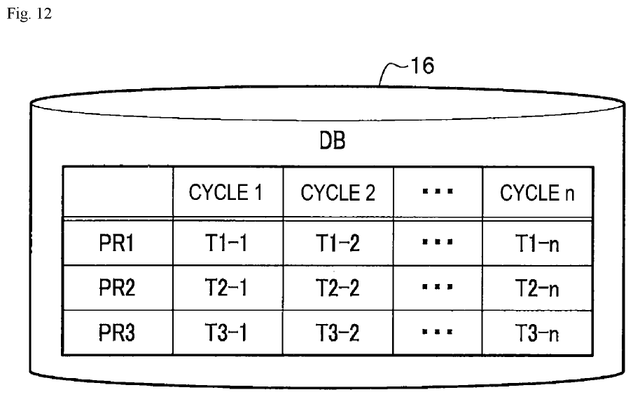

In step S7, the latency calculation unit 17 calculates a latency time T1-1 (FIG. 12) from the difference between the transmission time information Tin1 and the reception time information Tout1 marked on the test packet PR1, and stores this latency time information T1-1 in the DB 16 illustrated in FIG. 12 in association with the path information R1.

The DB 16 stores latency time information T obtained by periodically transmitting and/or receiving each of the test packets PR1 to PR3 on the NW 30. In other words, the DB stores latency time information T1-1 of the first cycle (cycle 1) obtained when the test packet PR1 is transmitted and/or received first time for measurement, latency time information T1-2 of the second cycle (cycle 2) obtained when the test packet is transmitted and/or received second time for measurement, . . . , and latency time information T1-n of the n-th cycle (cycle n) obtained when the test packet is transmitted and/or received n-th time for measurement. Similarly, the DB stores latency time information T2-1 obtained when the test packet PR2 is transmitted and/or received first time, latency time information T2-2 obtained when the test packet is transmitted and/or received second time, . . . , and latency time information T2-n when the test packet is transmitted and/or received n-th time. Similarly, the DB stores latency time information T3-1 obtained when the test packet PR3 is transmitted and/or received first time, latency time information T3-2 obtained when the test packet is transmitted and/or received second time, . . . , and latency time information T3-n when the test packet is transmitted and/or received n-th time.

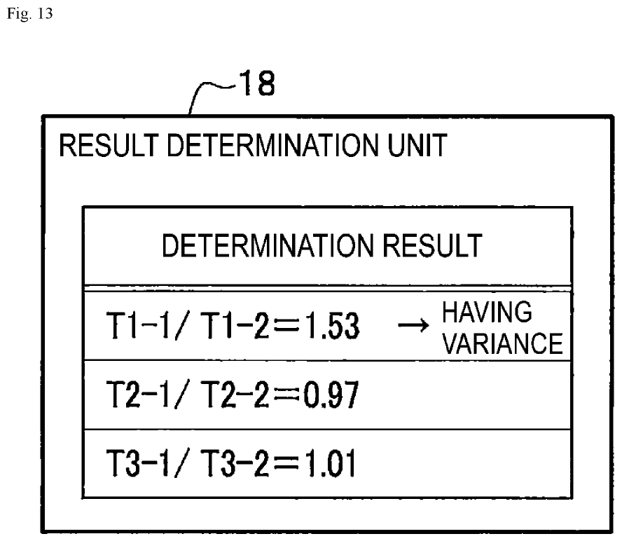

Next, in step S8, the result determination unit 18 determines a latency state of a predetermined path on the NW 30 based on the stored information in the DB 16. For example, for the path related to the path information R1, the latency time information T1-1 of the cycle 1 is divided by the latency time information T1-2 of the cycle 2 to obtain a variance 1.53 of the latency time as illustrated in FIG. 13. This variance 1.53 indicates that the latency time has increased by 53% in the current cycle 2 than in the previous cycle 1. Thus, the result determination unit 18 determines that the latency time has varied.

In addition, for the path related to the path information R2, the latency time information T2-1 of the cycle 1 is divided by the latency time information T2-2 of the cycle 2 to obtain a variance 0.97 of the latency time. This variance 0.97 indicates that the latency time has been reduced by 3% in the current cycle 2 than in the previous cycle 1. Therefore, it is determined that the latency time has not varied.

In addition, for the path related to the path information R3, the latency time information T3-1 of the cycle 1 is divided by the latency time information T3-2 of the cycle 2 to obtain a variance 1.01 of the latency time. This variance 1.01 indicates that the latency time has increased by 1% in the current cycle 2 than in the previous cycle 1. Therefore, it is determined that the latency time has not varied.

In this manner, the result determination unit 18 can determine whether the difference between the previous cycle and the current cycle exceeds a certain percentage and thus the latency time has varied. In other words, it can be determined whether the latency time tends to increase or decrease. In addition, it is possible to determine which cycle has a significant gap in latency times, how long the gap continues, and the like using data obtained by training latency times of each of cycles for a predetermined period of time.

### Effects of Embodiment

Next, effects of the latency measurement apparatus 10 according to the present embodiment will be described.

(1) The latency measurement apparatus 10 includes the topology detection unit 13, the path determination unit 14, the test packet generation unit 15, the latency calculation unit 17, and the DB 16.

The topology detection unit 13 collects routing information (routing protocol information) from the NW 30 to which the plurality of nodes are network-connected to detect topology information. The path determination unit 14 determines inter-node path information of the path to be measured for latency based on the detected topology information. The test packet generation unit 15 generates a test packet to be transmitted to the path based on the determined path information.

The timestamp marking unit 20 performs time-keeping and performs transmission and/or reception of a packet, marks the test packet generated by the test packet generation unit 15 with transmission time information based on the time-keeping when the test packet is transmitted to the path according to inter-node path information, and marks the test packet with reception time information based on the time-keeping when the test packet is received from the path. The latency calculation unit 17 is configured to calculate the latency time from the difference between the transmission time information and the reception time information marked on the test packet, and store the calculated latency time information in the DB 16 in association with the inter-node path information on the latency time information.

According to this configuration, the path determination unit 14 determines the inter-node path information for the path to be measured for latency based on the topology information detected by the topology detection unit 13. The transmission time information is marked when the test packet is transmitted to the path of the path information, and the reception time information is marked when the test packet is received from the path. The latency time can be calculated from the difference between the marked transmission time information and reception time information.

This configuration of latency measurement described above can be realized with a simple device configuration in which a generated test packet is transmitted to the path to be measured for latency, the transmission and/or reception times are marked on the test packet (timestamping) at the time of the transmission, and the difference between the transmission and/or reception times os obtained. Thus, the latency measurement apparatus 10 that can measure latency in the required node segment on the NW 30 and ascertain latency in the node segment on the network can be realized at a low cost.

In addition, because the timestamping of the transmission time information and the reception time information on the test packet by the marking unit 20 can be processed with the same hardware, latency can be measured with high accuracy. Thus, latency measurement can be achieved such that effects of fluctuations in microsecond orders and due to processing conflicts can be minimized by marking a timestamp which serves as a reference for latency measurement with hardware processing. In addition, because the hardware configuration enables the insertion of the timestamp at the same time kept by the time-keeping unit 19, time synchronization between devices is unnecessary, and time information can be inserted with high accuracy.

(2) The path determination unit 14 is configured to use a node directly connected to the timestamp marking unit 20 on the NW 30 as a start/end point and determines a plurality of pieces of loop path information corresponding to different loops that the test packet passes through.

According to this configuration, it is assumed that, when a test packet passes through the loop path in the rightward direction from the node serving as the start/end point and returns to the node serving as the start/end point according to loop path information, the increase in latency from, for example, “10” of the previous time to, for example, “18” of the current time is measured. On the other hand, it is assumed that latency does not change from “8” of the previous time to “8” of the current time on this loop in the leftward direction. In this case, it is possible to infer an increase in the rightward direction and no-change in the leftward direction from the difference in latency between the previous time and the current time in the rightward or leftward directions. Thus, it is ascertained from the inference result that the latency has increased by “8” on the loop path in the rightward direction. In this manner, it is possible to easily infer an increase or decrease in latency on the same loop path in the rightward and leftward directions.

(3) The path determination unit 14 is configured to determine a plurality of pieces of round-trip path information of paths between the node serving as the start/end point and a node other than the node serving as the start/end point, and determine, among them, a round-trip path in the node segment other than the node serving as the start/end point from the difference between paths of the round-trip information, the paths having a common path from the end/start point and having different lengths.

According to this configuration, the round-trip path information of the node segment other than the node serving as the start/end point, in other words, latency information for a round-trip in the node segment that is the only segment unavailable for transmission of the test packet, can be obtained. Thus, the round-trip latency of the node segment that is the only segment unavailable for transmission of the test packet can be determined.

(4) The test packet generation unit 15 is configured to set a priority in the header of the test packet according to various communication services.

According to this configuration, as priority set in the header of the test packet according to various communication services, for example, priority 7 for a telephone service having a high importance, and priority 1 for the Internet service are set. With this setting, when a test packet with priority 7 and a test packet with priority 1 enter the same node, the test packet with priority 7 for the telephone service can be preferentially transmitted.

(5) The nodes on the NW 30 are configured to perform test packet transfer in a label switching manner.

According to this configuration, a label indicating a transfer destination node in accordance with the path information of the path to be measured for latency can be inserted into the test packet, and the test packet can be transferred (transmitted) on a loop path or a round-trip path. Thus, the test packet can be properly transferred on the path to be measured.

(6) The result determination unit 18 for determining a difference in latency time between a previous measurement cycle and a current measurement cycle for the path of the same node segment, based on latency time information of each piece of path information stored in the DB 16 is further provided.

According to this configuration, it is possible to determine whether the difference in latency time between the previous measurement cycle and the current measurement cycle exceeds a certain percentage. Thus, it can be determined whether the latency time tends to increase or decrease.

Next, a program executed by a computer according to the present embodiment will be described. It is assumed that the computer is the latency measurement apparatus 10 that measures a latency time between nodes on the communication network.

A program causes the computer to function as a section that collects routing information from the communication NW 30 to which the plurality of nodes 1n to 5n are network-connected to detect topology information, a section that determines inter-node path information of nodes to be measured based on the detected topology information, a section that generates a test packet to be transmitted on a path based on the determined path information, a section that performs time-keeping and performs transmission and/or reception of a packet, marks the generated packet with transmission time information based on the time-keeping when the packet is transmitted to the path according to the inter-node path information, and marks the packet with reception time information based on the time-keeping when the packet is received from the path, and a section that calculates a latency time from a difference between the transmission time information and the reception time information marked on the packet and stores the calculated latency time information in the DB 16 in association with the inter-node path information related to the latency time information.

According to this program, it is possible to obtain effects similar to those of the aforementioned latency measurement apparatus 10.

Effects

(1a) The latency measurement apparatus includes a detection unit that collects routing protocol information from a communication network constituted by a plurality of nodes network-connected to one another to detect topology information, a path determination unit that determines inter-node path information of nodes to be measured for latency based on the detected topology information, a generation unit that generates a packet to be transmitted on a path based on the determined path information, a marking unit that performs time-keeping and performs transmission and/or reception of a packet, marks the packet generated by the generation unit with transmission time information based on the time-keeping when the packet is transmitted to the path according to the inter-node path information, and marks the packet with reception time information based on the time-keeping when the packet is received from the path, and a calculation unit that calculates a latency time from a difference between the transmission time information and the reception time information marked on the packet and stores the calculated latency time information in a database (DB) in association with the inter-node path information related to the latency time information.

According to this configuration, the path determination unit determines the inter-node path information for the path to be measured for latency based on the topology information detected by the detection unit. The transmission time information is marked when the packet is transmitted to the path of the path information, and the reception time information is marked when the packet is received from the path. The latency time can be calculated from the difference between the marked transmission time information and reception time information. This configuration of latency measurement can be realized with a simple device configuration in which a generated packet is transmitted to the path to be measured for latency, the transmission and/or reception times are marked on the packet (timestamping) at the time of the transmission, and the difference between the transmission and/or reception times can be obtained. Thus, the latency in the required node segment on the communication network can be measured, and the latency in the node segment on the network can be ascertained at a low cost.

(2a) The latency measurement apparatus described in (1a) above has the path determination unit that uses a node directly connected to the marking unit as a start/end point on the communication network, and determines a plurality of pieces of loop path information corresponding to different loops that the packet passes through.

According to this configuration, it is assumed that, when a packet passes through the loop path in the rightward direction from the node serving as the start/end point and returns to the node serving as the start/end point according to loop path information, the increase in latency from, for example, “10” of the previous time to, for example, “18” of the current time is measured. On the other hand, it is assumed that latency does not change from “8” of the previous time to “8” of the current time on this loop in the leftward direction. In this case, it is possible to infer an increase in the rightward direction and no-change in the leftward direction from the difference in latency between the previous time and the current time in the rightward or leftward directions. Thus, it is ascertained from the inference result that the latency has increased by “8” on the loop path in the rightward direction. In this manner, it is possible to easily infer an increase or decrease in latency on the same loop path in the rightward and leftward directions.

(3a) The latency measurement apparatus described in (2a) above has the path determination unit configured to determine a plurality of pieces of round-trip path information of paths between the node serving as the start/end point and a node other than the node serving as the start/end point, and determine a round-trip path in the node segment other than the node serving as the start/end point from the difference between paths of the round-trip path information, the paths having a common path from the end/start point and having different lengths.

According to this configuration, the round-trip path information of the node segment other than the node serving as the start/end point, in other words, latency information for a round-trip in the node segment that is the only segment unavailable for transmission of the packet can be obtained. Thus, the round-trip latency of the node segment that is the only segment unavailable for transmission of the packet can be determined.

(4a) The generation unit is configured to set priority in the header of the packet according to various communication services.

According to this configuration, as priority set in the header of the test packet according to various communication services, for example, priority 7 for a telephone service having a high importance, and priority 1 for the Internet service are set. With this setting, when a test packet with priority 7 and a test packet with priority 1 enter the same node, the test packet with priority 7 for a telephone service can be preferentially transmitted.

(5a) The latency measurement apparatus described in any one of (1a) to (43a) above, in which a node on the communication network transfers a packet in a label switching manner.

According to this configuration, a label indicating a transfer destination node in accordance with the path information of the path to be measured for latency can be inserted into the packet, and the packet can be transferred (transmitted) on a loop path or a round-trip path. Thus, the packet can be properly transferred on the path to be measured.

(6a) The latency measurement apparatus described in any one of (1a) to (5a) further includes a determination unit that determines, based on latency time information for each piece of path information stored in the DB, a difference in latency time between a previous measurement cycle and a current measurement cycle for the path of the same node segment.

According to this configuration, it is possible to determine whether the difference in latency time between the previous measurement cycle and the current measurement cycle exceeds a certain percentage. In addition, it can be determined whether the latency time tends to increase or decrease.

(7a) A latency measurement method is a method performed by a latency measurement apparatus that measures a latency time between nodes on a communication network, in which the latency measurement apparatus performs a step of collecting routing protocol information from the communication network constituted by a plurality of nodes network-connected to one another to detect topology information, a step of determining inter-node path information of nodes to be measured for latency based on the detected topology information, a step of generating a packet to be transmitted on a path based on the determined path information, a step of performing time-keeping and performing transmission and/or reception of a packet, marking the generated packet with transmission time information based on the time-keeping when the packet is transmitted to the path according to the inter-node path information, and marking the packet with reception time information based on the time-keeping when the packet is received from the path, and a step of calculating a latency time from a difference between the transmission time information and the reception time information marked on the packet and storing the calculated latency time information in a DB in association with the inter-node path information related to the latency time information.

Using this method, the same operational effects as described in (1a) above can be achieved.

(8a) A program causes a computer to function as the latency measurement apparatus described in any one of (1a) to (6a) above.

Using this program, the same operational effects as any one of in (1a) to (6a) described above can be achieved.

Other appropriate changes can be made to the specific configurations without departing from the spirit of the present invention.

### REFERENCE SIGNS LIST

10 Latency measurement apparatus
11 Timestamp marker
12 Test packet generator
13 Topology detection unit
14 Path determination unit
15 Test packet generation unit
16 DB
17 Latency calculation unit
18 Result determination unit
19 Time-keeping unit
20 Timestamp marking unit
30 Communication network (NW) to be measured
1n to 5n Node

1. A latency measurement apparatus, comprising:
a detection unit, including one or more processors, configured to collect routing information from a communication network formed by a plurality of nodes network-connected to one another to detect topology information, the routing information indicating an inter-node connection state;
a path determination unit, including one or more processors, configured to determine, based on the detected topology information, inter-node path information of nodes to be measured for latency;
a generation unit, including one or more processors, configured to generate a packet to be transmitted on a path based on the determined inter-node path information;
a marking unit, including one or more processors, configured to perform time-keeping and perform transmission and/or reception of a packet, mark the packet generated by the generation unit with transmission time information based on the time-keeping when the packet is transmitted to the path according to the inter-node path information, and mark the packet with reception time information based on the time-keeping when the packet is received from the path; and
a calculation unit, including one or more processors, configured to calculate a latency time information from a difference between the transmission time information and the reception time information marked on the packet and store the calculated latency time information in a database (DB) in association with inter-node path information related to the latency time information.

2. The latency measurement apparatus according to claim 1,
wherein the path determination unit is configured to use a node directly connected to the marking unit as a start/end point on the communication network, and determine a plurality of pieces of loop path information corresponding to different loops that the packet passes through.

3. The latency measurement apparatus according to claim 2,
wherein the path determination unit is configured to determine a plurality of pieces of round-trip path information of a plurality of paths between the node serving as the start/end point and a node other than the node serving as the start/end point, and determine a round-trip path in a node segment other than the node serving as the start/end point from a difference between the plurality of paths of the round-trip path information, the paths having a common path from the start/end point and having different lengths.

4. The latency measurement apparatus according to claim 3,
wherein the generation unit is configured to set a priority in a header of the packet according to various types of communication services.

5. The latency measurement apparatus according to claim 4,
wherein a node on the communication network transfers a packet in a label switching manner.

6. The latency measurement apparatus according to claim 5, further comprising:
a determination unit configured to determine, based on latency time information for an individual piece of path information stored in the DB, a difference in latency time between a previous measurement cycle and a current measurement cycle for a path of a same node segment.

7. A latency measurement method performed by a latency measurement apparatus the method comprising:
by the latency measurement apparatus,
collecting routing information from a communication network formed by a plurality of nodes network-connected to one another to detect topology information, the routing information indicating an inter-node connection state;
determining, based on the detected topology information, inter-node path information of a plurality of nodes to be measured for latency;
generating a packet to be transmitted on a path based on the determined inter-node path information,
performing time-keeping and transmission and/or reception of a packet, marking the generated packet with transmission time information based on the time-keeping when the packet is transmitted to a path according to the inter-node path information, and marking the packet with reception time information based on the time-keeping when the packet is received from the path; and
calculating a latency time information from a difference between the transmission time information and the reception time information marked on the packet and storing the calculated latency time information in a DB in association with the inter-node path information related to the latency time information.

8. A non-transitory computer-readable medium storing software comprising instructions executable by one or more computers which, upon such execution, cause the one or more computers to perform operations comprising:
collecting routing information from a communication network formed by a plurality of nodes network-connected to one another to detect topology information, the routing information indicating an inter-node connection state;
determining, based on the detected topology information, inter-node path information of a plurality of nodes to be measured for latency;
generating a packet to be transmitted on a path based on the determined inter-node path information,
performing time-keeping and transmission and/or reception of a packet, marking the generated packet with transmission time information based on the time-keeping when the packet is transmitted to a path according to the inter-node path information, and marking the packet with reception time information based on the time-keeping when the packet is received from the path; and
calculating latency time information from a difference between the transmission time information and the reception time information marked on the packet and storing the calculated latency time information in a DB in association with the inter-node path information related to the latency time information.

9. The latency measurement method according to claim 7, further comprising:
using a node directly connected to a marking unit as a start/end point on the communication network; and
determining a plurality of pieces of loop path information corresponding to different loops that the packet passes through.

10. The latency measurement method according to claim 9, further comprising:
determining a plurality of pieces of round-trip path information of a plurality of paths between the node serving as the start/end point and a node other than the node serving as the start/end point; and
determining a round-trip path in a node segment other than the node serving as the start/end point from a difference between the plurality of paths of the round-trip path information, the paths having a common path from the start/end point and having different lengths.

11. The latency measurement method according to claim 10, further comprising setting a priority in a header of the packet according to various types of communication services.

12. The latency measurement method according to claim 11, further comprising transferring, by a node on the communication network, a packet in a label switching manner.

13. The latency measurement method according to claim 12, further comprising determining, based on latency time information for an individual piece of path information stored in the DB, a difference in latency time between a previous measurement cycle and a current measurement cycle for a path of a same node segment.

14. The non-transitory computer-readable medium according to claim 8, further comprising:
using a node directly connected to a marking unit as a start/end point on the communication network; and
determining a plurality of pieces of loop path information corresponding to different loops that the packet passes through.

15. The non-transitory computer-readable medium according to claim 14, further comprising:
determining a plurality of pieces of round-trip path information of a plurality of paths between the node serving as the start/end point and a node other than the node serving as the start/end point; and
determining a round-trip path in a node segment other than the node serving as the start/end point from a difference between the plurality of paths of the round-trip path information, the paths having a common path from the start/end point and having different lengths.

16. The non-transitory computer-readable medium according to claim 15, further comprising setting a priority in a header of the packet according to various types of communication services.

17. The non-transitory computer-readable medium according to claim 16, further comprising transferring, by a node on the communication network, a packet in a label switching manner.

18. The non-transitory computer-readable medium according to claim 17, further comprising determining, based on latency time information for an individual piece of path information stored in the DB, a difference in latency time between a previous measurement cycle and a current measurement cycle for a path of a same node segment.

19. The latency measurement method according to claim 7, further comprising measuring a latency time between the plurality of nodes on the communication network.

20. The non-transitory computer-readable medium according to claim 8, further comprising measuring a latency time between the plurality of nodes on the communication network.
